(19) United States
(12) Patent Application Publication
(10) Pub. No.: US 2025/0217271 A1
(43) Pub. Date: Jul. 3, 2025

(54) DEVICE AND METHOD FOR DEBUGGING A VIDEO GAME

(71) Applicant: Garena Online Private Limited, Singapore (SG)

(72) Inventor: Harold TEO Ron Han, Singapore (SG)

(21) Appl. No.: 18/400,556

(22) Filed: Dec. 29, 2023

(30) Foreign Application Priority Data
Dec. 21, 2022 (SG) 10202260544V

(51) Int. Cl. G06F 11/36; A63F 13/60; G06F 3/0481; G06F 3/0484

(52) U.S. Cl. CPC G06F 11/3698; A63F 13/60; G06F 11/3636; G06F 3/0481; G06F 3/0484

(57) ABSTRACT

Aspects of the disclosed technology provide solutions for debugging a video game. In some aspects, steps of a method of the disclosed technology can include: representing game logic of a video game as a graph, visually presenting the graph in a graphical user interface in the form of connected nodes, setting, according to an interaction with a user with the input connection point, a breakpoint at an input connection point of the node and/or at an output connection point of the node, and performing a test run of the game logic wherein for each breakpoint a state of the variable whose processing is represented by the node is displayed in the graphical user interface together with the visually presented graph. A game development device and computer-readable media are also provided.

### CROSS REFERENCE TO RELATED APPLICATIONS

This patent application claims the benefit and priority of Singaporean patent application number 10202260544V filed with the Intellectual Property Office of Singapore on Dec. 21, 2022, the disclosure of which is incorporated by reference herein in its entirety as part of the present application.

### TECHNICAL FIELD

Various aspects of this disclosure relate to devices and methods for debugging a video game.

### BACKGROUND

In today's game development, the development of upper-level game logic (such as skills, AI (artificial intelligence), level logic, etc.) is becoming more and more complex and changeable.

In the traditional workflow in which the upper-level logic of a game (such as rules that govern gameplay mechanics according to the game design) through configuration (table configuration, editor configuration, etc.) is implemented, first, a game designer needs to put forward the development requirements of related functions to the programmer. After the development of these functions is completed, the game designer follows the agreed rules to configure and test these functions to implement upper-level logic of the game in order to complete the development of the game. During this process, the game designer needs to wait for the programmer to complete the development of the functions before proceeding to the next step in the development of the game, e.g. configuring the functions according to the intended upper-level logic, and some designs may not be final and require further verification. If further iteration is required, the previous steps need to be repeated, so in this process, game designers rely more on programmers to implement their functions. When implementing the upper-level logic of the game by writing scripts (such as using Lua or Python, etc.), the game designer also needs to wait for the programmer to provide the corresponding API for the upper-level logic, and needs a certain programming ability to write script code.

Approaches are desirable to meet the needs of game designers to quickly create and verify a large number of upper-level game logic who do not want every requirement to be manually written by the programmer. Specifically, approaches are desirable which provide game designers with the ability to develop and verify a large number of upper-level logics of games without programming ability.

### SUMMARY

Various embodiments concern a method for debugging a video game, comprising representing game logic of a video game as a graph, visually presenting the graph in a graphical user interface in the form of connected nodes, wherein one or more of the connected nodes each comprise an input connection point and an output connection point and wherein the one or more of the connected nodes represent the processing of a variable, supplied at its input connection point, to a result, output by the node at its output connection point, according to the game logic, and comprising, for a node of the one or more of the connected nodes, at least one of
setting, according to an interaction with a user with the input connection point, a breakpoint at the input connection point and,
setting according to an interaction with a user with the output connection point, a breakpoint at the output connection point and performing a test run of the game logic wherein,
for each breakpoint at an input connection point of a node, a state of the variable whose processing is represented by the node comprising the input connection point which the variable has before processing by the node is displayed in the graphical user interface together with the visually presented graph and
for each breakpoint at an output connection point of a node, a state of the variable whose processing is represented by the node comprising the output connection point which the variable has after processing by the node is displayed in the graphical user interface together with the visually presented graph.

According to one embodiment, each graph comprises at least one source node having an output connection point but no input connection point.

According to one embodiment, each graph comprises at least one sink node having an input connection point but no output connection point.

According to one embodiment, for each graph, the connected nodes are connected between the at least one source node and the at least one sink node by connections, wherein each connection is connected to an input connection point of one of the nodes and an output connection point of another one of the nodes.

According to one embodiment, the method comprises creating the graph according to user input via the graphical user interface.

According to one embodiment, the method comprises providing, for each node, program code implementing node logic realizing processing represented by the node.

According to one embodiment, the method comprises, for at least one of the connected nodes, setting parameters of the node logic according to user input via the graphical user interface.

According to one embodiment, the variable is a variable including information about movement of a character or non-player character, about degree of success of an action or skill or a character or non-player character, about a state of a character or non-player character or about a state of a game world.

According to one embodiment, the interaction of the user with the input connection point comprises a marking of the input connection point by a mouse click or touch by the user.

According to one embodiment, the interaction of the user with the output connection point comprises a marking of the output connection point by a mouse click or touch by the user.

According to one embodiment, a game development device is provided comprising a user interface, a memory and a processing unit configured to perform the method of any one of the embodiments described above.

According to one embodiment, a computer program element is provided comprising program instructions, which, when executed by one or more processors, cause the one or more processors to perform the method of any one of the embodiments described above.

According to one embodiment, a computer-readable medium is provided comprising program instructions, which, when executed by one or more processors, cause the one or more processors to perform the method any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a data processing device like a computer or smartphone.

FIG. 2 shows a graphical user interface for node-based visual editing of game logic.

FIG. 3 shows a flow diagram illustrating a processing flow for game development.

FIG. 4 shows a graphical user interface (GUI) of a visualized game logic system used for debugging.

FIG. 5 shows a flow diagram illustrating a method for debugging a video game according to one embodiment.

FIG. 6 shows a game development device according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

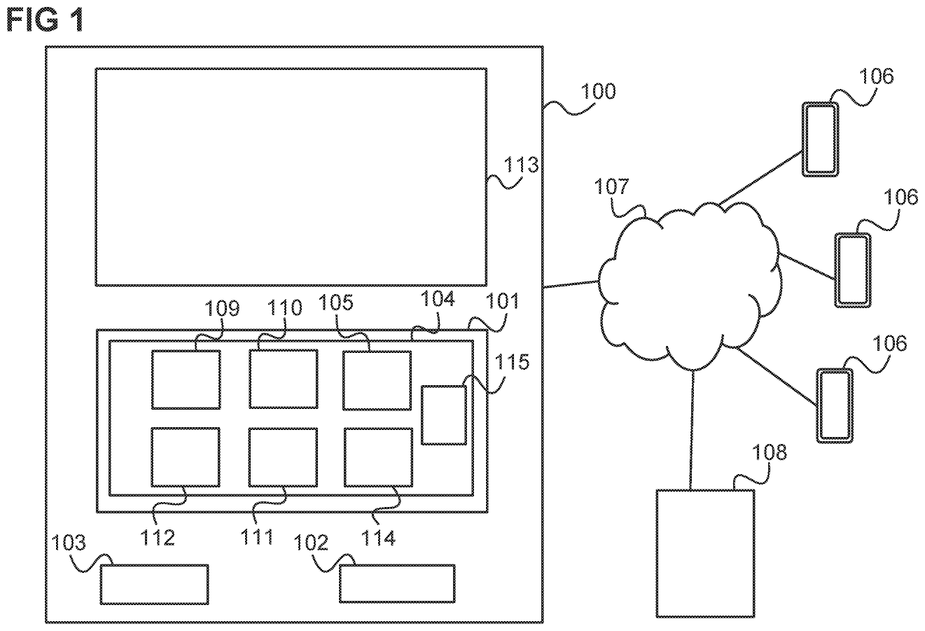

FIG. 1 shows a data processing device 100 like a computer or smartphone.

The data processing device 100 has a CPU (central processing unit) 101 and a random access memory (RAM) 102. The RAM 102 is used to load program code, for example from a hard disk 103, and the CPU 101 executes the program code. The data processing device 100 further includes a screen 113.

In the present example, it is assumed that a user intends to use the data processing device 100 to create game logic for a video game, i.e. the data processing device 100 can also be seen as a game development device.

To do so, the user executes and interacts with a game development environment 104 on the CPU 101.

The (game) development environment 104 enables the user to create game logic for a video game 105. The video game intended for various gaming devices 106, i.e., target hardware. For example, the gaming devices 106 are handheld devices, such as smartphones or tablets or dedicated handheld gaming devices.

The user of the data processing device 100 may distribute the finished game 105 to appropriate gaming devices 106 via a communication network 107. For example, the user uploads the created game a server 108 (connected to the communication network 107) from which users of the other gaming devices 106 may download it.

It should be noted that in particular in complex games, multiple users may be involved in the development so multiple users may create or update a part of the game logic (e.g. each one on a respective data processing device 100 in communication with a development environment hosted on a server 108) and other users may create or update other parts of the game and take care of the distribution of the game 105.

In particular, in a complex game, there are game designers and programmers and the game designers may not necessarily have much experience in programming. Even with the requisite experience, it may be inefficient for game designers or programmers to perform full-stack development. To allow game designers without programming ability to develop and verify a large number of upper-level logics of games, various embodiments of the subject technology apply node-based visual editing, wherein game logic is represented as one or more graphs. This makes the development process more convenient and transparent instead of black-box operation, and can let the game designers fully control the development of the upper-level logic of the game in a more formal and explicit way.

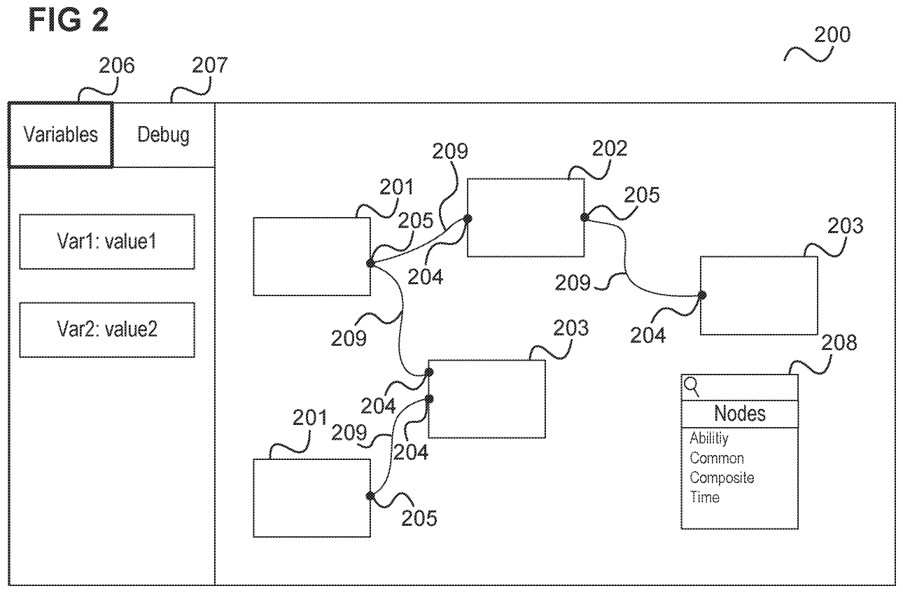

FIG. 2 shows a graphical user interface 200, e.g. displayed on screen 113, for node-based visual editing of game logic.

According to various embodiments, the development environment 104 comprises a visualized game logic system. The visualized game logic system is an event-based virtual scripting system which the user (game designer) may use to develop the upper-level logic of the game 105. The visualized game logic system provides a node-based editing mode where, by interacting with nodes of a visual representation of upper-level game logic, a game designer can quickly implement upper-level game logic such as skills, states, levels, and AI (artificial intelligence) by connecting nodes 201, 202, 203 with connections 209. In other words, the game logic (which may be part of the complete game logic of a video game) is represented as a graph with the nodes 201 and the connections 209 as edges.

Some of the nodes are sink nodes 203 having only one or more input connection points 204 (e.g. a node causing movement of a player character), some of the nodes are source nodes 201 having one or more output connection points 205 (e.g. a node listening to events or a node representing acquiring an input from the player) and one or more of the nodes are intermediate (or “processing”) nodes 202 intermediate or processing nodes may have one or more input connection points 204 one or more output connection points 205 and process one or more input variables received at their one or more input connection points 204 (from one or more upstream nodes connected there) to one or more outputs (e.g. determine values of the outputs as a function of the one or more input variables) output at their output connection points 205 (to one or more downstream nodes connected there).

While representing game logic as graphs as illustrated in FIG. 2 may simplify implementing game logic for a game designer, development tools providing such a representation as graphs may still be rather general (visual) programming systems. For those kinds of systems, users still need to have certain programming skills, and the systems are typically developed in a way of thinking of program development. For the average game designer, this is a relatively high threshold. It is difficult for game designers to use to develop complex upper-level game logic and are prone to logic errors due to lacking program development experience.

Therefore, according to various embodiments, while maintaining representation of game logic as graphs, a visualized game logic system is provided that not only uses representation of game logic as graphs but encapsulates and constrains for commonly used events and functions in games (e.g. for turn-based games but also for real-time game types). For example, a specific type of graph can only listen to specific events (e.g. has source nodes for specific events such as keyboard input), and processing nodes represent basic functions of a certain upper-level logic (such as judging whether an object is an enemy, finding skill targets, opening a certain UI, etc.) rather than the basic function of a whole complex program, etc. This provides the game designer with better accessibility and thus allows the game designer to effectively avoid logic errors and quickly complete the development of upper-level logic.

Further, according to various embodiments, the visualized game logic system comprises (according to the concept of an environment similar to a sandbox) an independent graph runtime environment, which allows running multiple environments with different functions at the same time without interfering with each other (such as a normal game environment and a predicted game environment, e.g. a game environment predicted in case of a certain player action wherein the predicted outcome may differ from the actual outcome due to randomization (e.g. random number generator influence on the outcome)).

A runtime environment operating according to the game logic receives a player command as input (which may then be provided, e.g. accessed, by source nodes 201). The game logic is deterministic, that is, the same command input leads to the same result (in the logic flow, possibly not in the game outcome, e.g. a damage, where randomization may be used). This is beneficial for the upper-level game logic to realize functions such as archiving. rollback, and network synchronization.

In the following, terms used herein in context of the visualized game logic system are explained:
1. Scope (of variables): used to describe the levels of the existence of variables. The levels include game environment (equivalent to global variables, which can be accessed and modified by all graph runners (see item 6 below) and graph instances under it, such as the round of the game), graph runner (can be accessed by all graph instances under it), graph (only the interior of graph instance can be accessed and modified, such as skill cooldown), task (temporary variables of a certain execution process in graph instance, such as which targets are found).
2. Variable: used to store the data of the upper-level logic in different scopes, and the variable name is required to be unique in the same scope. Variables support multiple types (such as integer, floating-point, string, container, etc.)
3. Event: used to drive logic execution. The system provides some built-in events (such as game start, player death, etc.). Game designers can also add custom events. The event listening node of a graph (which is a source node 201), as a logical entry, is subscribed to these events and reacts to them according to the subscription priority. So, an event listening node which is chosen to be subscribed to a certain event by the game designer is supplied by the game engine with the information that the event has occurred and reacts to the event according to its associated logic, in particular entry into the game logic of the graph whose source node the event listening node is. In accordance with certain embodiments, a specific graph can only listen to specific events because some events can only be listened to in certain graphs. For example, for the event “release skill”, only the “skill” graph listens to it. The programming process may thus be simplified by providing fundamental components required for realizing game logic. These components are used by game designers to organize game logic.
4. Graph visualized editor 115: used to create graphs, add and connect nodes, set input and output of nodes, enable and disable breakpoints of nodes, and manage variables required by a graph.
5. Game environment component 109: used for the life cycle management of game environment, such as creating and destroying game environment, and maintaining variables under the scope of game environment.
6. Graph runner component 110: used for graph lifecycle management, such as creating one or more graph runners (or graph runner instances) and maintaining variables under the scope of graph runner. A graph runner can be seen as a carrier of a graph at runtime (e.g. on the development device 100 for testing the game as well as on the gaming devices 106 when playing the game). For example, a monster acts as a graph runner, and the graph runner runs the graph of AI behavior and the graph of skill for that monster. The graph runners are provided by the game engine running on the game development device 100 or the gaming device 106, respectively.
7. Graph instance component 111: used for life cycle management of graph (running) instances and maintaining variables under the scope of graph instances. For example, there may be several identical monsters in a battle, and they all refer to the graph of the same skill. At runtime, a graph instance is created for each monster based on the graph of this skill to execute the skill logic. The graph of monster actions is the same. Assuming that these monsters use the same behavior, they can refer to the graph of the same AI behavior and create their own graph instances at runtime.
8. Graph debug tool 112: used to view the contents of each environment, such as variables, which graph runners are included, and which graph instances are included in graph runner.
9. Gameplay debug tool 114: used to quickly simulate the game environment to test the upper logic, such as executing commands, sending events, etc. Commands in a game are for example “Move”, “Use skill”, and “End the round”. Each command triggers one or more corresponding events. The game designer handles only the logic of the corresponding event(s), but does not need to concern himself or herself with the input logic (allowing the player to input the command).

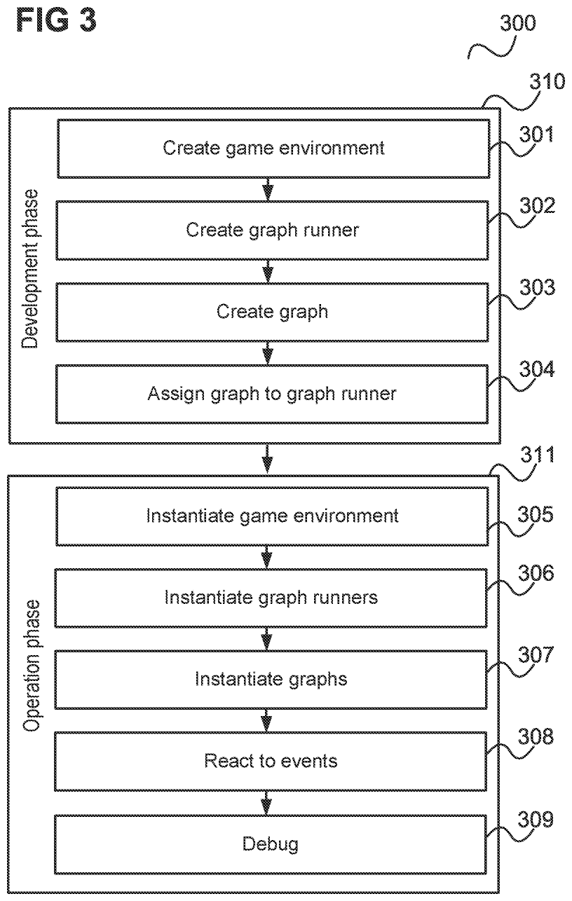

FIG. 3 shows a flow diagram 300 illustrating a processing flow for game development.

The processing flow includes a development phase 310 and an operation phase 311 (for testing or playing the game.

In the development phase, in 301, a game designer (or multiple game designers, reference will be made to a single one in the following for simplicity) create or select a game environment provided by the development environment 104.

In 302, the game designer creates a graph runner under this game environment (graph runner can be divided according to general logic, such as a monster, a non-player character (NPC), etc.).

In 303, the game designer creates a graph through the graph visualized editor 115 (e.g. with GUI 200), defines variables (type, name and scope) according to design requirements (e.g. using a variables menu 206 of the GUI 200), adds nodes 201, 202, 203 (e.g. using a pop-up menu 208) and connects them. Each graph must have an event listening node (e.g. a source node 201 such as listening to game start events and a character movement event) as an entry. The game designer sets the required inputs (such as variables defined in a scope, data provided by the system, node parameters etc.) and outputs (such as variables defined in a scope) for each node 201, 202, 203. A game designer can create a graph by adding nodes. The logic of the nodes is preset by programmers, so game designers do not need to do any coding. Through filling in parameters, game designers can realize the logic they want.

In 304, the game designer assigns the created graph to the corresponding graph runner.

The game designer does this for multiple graphs defining the game logic.

In the operation phase, in 305, the game engine instantiates the game environment and variables under the scope.

In 306, the game engine instantiates all graph runners under the game environment and variables under the scope.

In 307, the game engine instantiates all graphs under each graph runner and variables under the scope, and each graph instance subscribes to the events of interest.

In 308, after an event is triggered, each graph instance which has subscribed to the event responds and executes according to the priority of the subscription.

In 309, in case there is a problem, the game designer can use the relevant debugging tools 112, 114 for debugging (e.g. using a debug menu 207 of the GUI 200).

According to various embodiments, visualized game logic system provides a visualized debugging function (making use of function of the debugging tools 112, 114). This allows, e.g. using the debug menu 207 of the GUI 200 to set breakpoints in the node enter and exit stages (e.g. at an input connection point 204 and at an output connection point 205). This is convenient for the game designer to view value changes, the execution stack of the graph, etc., to quickly locate a problem.

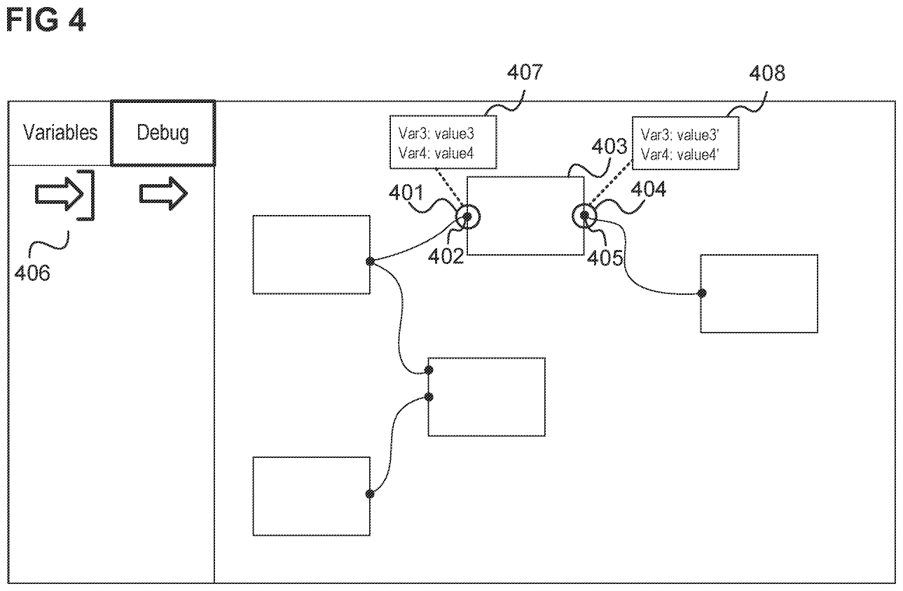

FIG. 4 shows a GUI 400 of the visualized game logic system used for debugging.

The GUI 400 corresponds to the GUI 200 but it is switched to debug mode instead of definition of variables mode.

In this example, the game designer has set a first breakpoint 401 at an input connection point 402 of a node 403 and a second breakpoint 404 at an output connection point 405 of the node 403. The game designer can do this for example by clicking on (or touching in case of a touch screen 113) the input connection point 404 and the output connection point 405, respectively (possibly followed by a selection operation or input of parameters related to options for the breakpoint).

The game designer may execute the game logic represented by the graph to which the node belongs (e.g. by setting variables to values for which the game designer wants to test the game logic and triggering an event listening node as if the event had occurred) in a manner such that the processing pauses at each breakpoint (e.g. by clicking on a corresponding button 406). Further, when the processing pauses at a certain breakpoint, in this example the first breakpoint 401, it displays the values of variables processed by the node 403, e.g. in a first window 407 for the first breakpoint 401 and a second window 408 for the second breakpoint 404 (wherein the values are entered in the corresponding window when the corresponding breakpoint has been reached). By pausing at the first breakpoint 401 and the second breakpoint and comparing the values, the game designer may examine whether the values have been processed correctly by the node 403.

The visualized game logic system may further have a breakpoint debugging function which automatically triggers breakpoints when there is an error in the graph logic (e.g. upon detection by the runtime environment that a variable or key used in a node is not defined), without requiring programmers to set breakpoints in the code which need to be debugged in advance every time. This feature simplifies the debugging process. This means that the game logic represented by the graph is run from the start and if there is a bug in the game logic, the game logic stops at a certain node (related to the bug). For example, details about the bug encountered may be displayed in a corresponding menu window (e.g. similar to 407 or 408 or below the button 406) like for example that a variable or key used in the node has not been defined. So, the breakpoints 204, 205 may include breakpoints which do not need to be preset by the user (game designer) but which are automatically activated if a bug is encountered. If there is no bug but the game designer finds that something needs to be adjusted the game designer may set a breakpoint by user interaction (e.g. click on one of the points representing the breakpoints 204, 205) to stop the logic there and adjust the graph.

Furthermore, the visualized game logic system may provide a preview window showing a preview of the game, e.g. the game designer may run the game and is presented with the game in the preview window.

In summary, according to various embodiments, a method is provided as illustrated in 5.

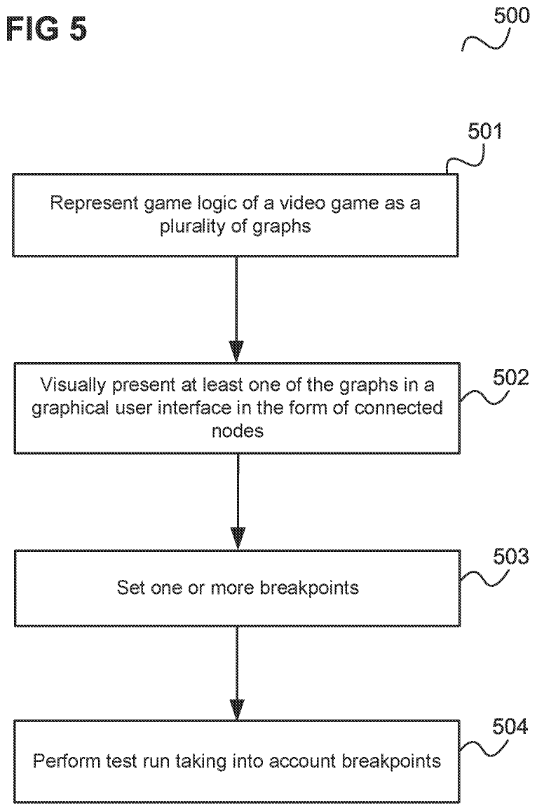

FIG. 5 shows a flow diagram 500 illustrating a method for debugging a video game according to one embodiment.

In 501, game logic of a video game is represented as a graph.

In 502, at least one of the graphs is presented in a graphical user interface in the form of connected nodes, wherein one or more of the nodes each comprise an input connection point and an output connection point and wherein the one or more of the connected nodes represent the processing of at least one variable, supplied at its input connection point, to a result, output by the node at its output connection point, according to the game logic.

In 503, for at least one of the one or more of the nodes, at least one of
a breakpoint at the input connection point setting is set according to an interaction with a user with the input connection point and
a breakpoint at the output connection point is set according to an interaction with a user with the output connection point.

In 504, a test run of the game logic is performed (e.g. in response to a corresponding user into via the GUI) wherein, for each breakpoint at an input connection point of a node, a state of the at least one variable whose processing is represented by the node comprising the input connection point which the variable has before processing by the node is displayed in the graphical user interface together with the visually presented graph and for each breakpoint at an output connection point of a node, a state of the at least one variable whose processing is represented by the node comprising the output connection point which the variable has after processing by the node is displayed in the graphical user interface together with the visually presented graph.

According to various embodiments, in other words, in a game design tool which uses graphs for representing and visually presenting (parts of) the game logic, a user may define break points at entry and exit stages of nodes and is, when a breakpoint is encountered, presented with the values of variables processed by the respective node. This allows conveniently debugging game logic. The approach of FIG. 5 thus allows improving the game development efficiency of the upper-level logic of video games.

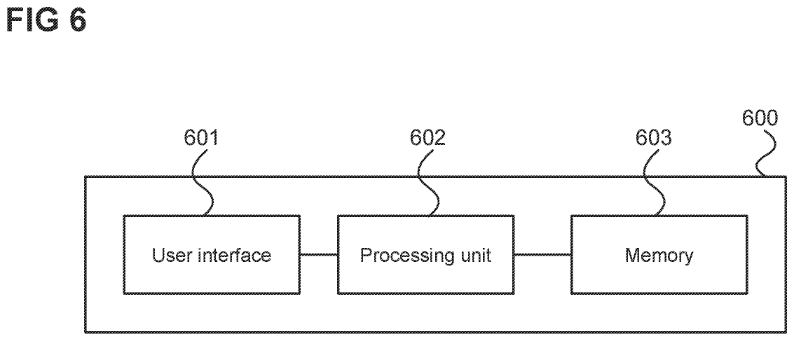

The method of FIG. 5 is for example carried out by a game development device (typically a computer) as illustrated in FIG. 6.

FIG. 6 shows a game development device 600 according to an embodiment.

The game development device 600 includes a user interface 601 (configured to receive user inputs). The game development device 600 further includes a processing unit 602 and a memory 603. The memory 603 may be used by the processing unit 602 to store, for example, the game logic (e.g. the definitions of the graphs created by one or more game designers), the program code of the game development environment etc. The game development device is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for debugging a video game, comprising:
representing game logic of a video game as a graph;
visually presenting the graph in a graphical user interface as one or more connected nodes, wherein the one or more connected nodes each comprise an input connection point and an output connection point, and wherein each of the one or more connected nodes represents processing for a variable supplied at its input connection point, to a result, output by the node at its output connection point, according to the game logic; and
for a node of the one or more of the connected nodes, at least one of:
setting, according to an interaction with a user with an input connection point, a breakpoint at the input connection point, and setting according to an interaction with the user with an output connection point, a breakpoint at the output connection point; and
performing a test run of the game logic wherein,
for each breakpoint at an input connection point of the node, a state of the variable whose processing is represented by the node comprising an input connection point which the variable has before processing by the node is displayed in the graphical user interface together with the visually presented graph; and
for each breakpoint at an output connection point of the node, a state of the variable whose processing is represented by the node comprising the output connection point which the variable has after processing by the node is displayed in the graphical user interface together with the visually presented graph.

2. The method of claim 1, wherein each graph comprises at least one source node having an output connection point but no input connection point.

3. The method of claim 2, wherein each graph comprises at least one sink node having an input connection point but no output connection point.

4. The method of claim 3, wherein, for each graph, the connected nodes are connected between the at least one source node and the at least one sink node by connections, wherein each connection is connected to an input connection point of one of the nodes and an output connection point of another one of the nodes.

5. The method of claim 1, further comprising: creating the graph according to user input via the graphical user interface.

6. The method of claim 1, further comprising: providing, for each node, program code implementing node logic realizing processing represented by the node.

7. The method of claim 6, comprising, for at least one of the connected nodes, setting parameters of the node logic according to user input via the graphical user interface.

8. The method of claim 7, wherein the variable is a variable including information about movement of a character or non-player character, a degree of success of an action or skill or a character or non-player character, a state of a character or non-player character or about a state of a game world, or a combination thereof.

9. The method of claim 1, wherein the interaction of the user with the input connection point comprises a marking of the input connection point by a mouse click or touch by the user.

10. The method of claim 1, wherein the interaction of the user with the output connection point comprises a marking of the output connection point by a mouse click or touch by the user.

11. A game development device comprising a user interface, a memory and a processing unit configured to perform operations for:
representing game logic of a video game as a graph;
visually presenting the graph in the user interface as one or more connected nodes, wherein the one or more connected nodes each comprise an input connection point and an output connection point, and wherein each of the one or more connected nodes represents processing for a variable supplied at its input connection point, to a result, output by the node at its output connection point, according to the game logic; and
for a node of the one or more of the connected nodes, at least one of:
setting, according to an interaction with a user with an input connection point, a breakpoint at the input connection point, and setting according to an interaction with the user with an output connection point, a breakpoint at the output connection point; and
performing a test run of the game logic wherein,
for each breakpoint at the input connection point of the node, a state of the variable whose processing is represented by the node comprising the input connection point which the variable has before processing by the node is displayed in the user interface together with the visually presented graph; and
for each breakpoint at the output connection point of the node, a state of the variable whose processing is represented by the node comprising the output connection point which the variable has after processing by the node is displayed in the user interface together with the visually presented graph.

12. The game development device of claim 11, wherein each graph comprises at least one source node having an output connection point but no input connection point.

13. The game development device of claim 12, wherein each graph comprises at least one sink node having an input connection point but no output connection point.

14. The game development device of claim 13, wherein, for each graph, the connected nodes are connected between the at least one source node and the at least one sink node by connections, wherein each connection is connected to an input connection point of one of the nodes and an output connection point of another one of the nodes.

15. The game development device of claim 11, wherein the processing unit is further configured to perform operations for:
creating the graph according to user input via the user interface.

16. The game development device of claim 11, wherein the processing unit is further configured to perform operations for:
providing, for each node, program code implementing node logic realizing processing represented by the node.

17. The game development device of claim 16, wherein for at least one of the connected nodes, setting parameters of the node logic is performed according to user input via the user interface.

18. The game development device of claim 17, wherein the variable is a variable including information about movement of a character or non-player character, a degree of success of an action or skill or a character or non-player character, a state of a character or non-player character or about a state of a game world, or a combination thereof.

19. The game development device of claim 11, wherein the interaction of the user with the input connection point comprises a marking of the input connection point by a mouse click or touch by the user.

20. A computer-readable medium comprising program instructions, which, when executed by one or more processors, cause the one or more processors to perform operations for:
representing game logic of a video game as a graph;
visually presenting the graph in a graphical user interface as one or more connected nodes, wherein the one or more connected nodes each comprise an input connection point and an output connection point, and wherein each of the one or more connected nodes represents processing for a variable supplied at its input connection point, to a result, output by the node at its output connection point, according to the game logic; and
for a node of the one or more of the connected nodes, at least one of:
setting, according to an interaction with a user with the input connection point, a breakpoint at the input connection point and, setting according to an interaction with the user with the output connection point, a breakpoint at the output connection point; and
performing a test run of the game logic wherein,
for each breakpoint at the input connection point of the node, a state of the variable whose processing is represented by the node comprising the input connection point which the variable has before processing by the node is displayed in the graphical user interface together with the visually presented graph; and
for each breakpoint at the output connection point of the node, a state of the variable whose processing is represented by the node comprising the output connection point which the variable has after processing by the node is displayed in the graphical user interface together with the visually presented graph.
